(19) United States
(12) Patent Application Publication
(10) Pub. No.: US 2025/0131402 A1
(43) Pub. Date: Apr. 24, 2025

(54) POINT-OF-SALE SYSTEM, METHOD, AND STORAGE MEDIUM

(71) Applicant: Toshiba Tec Kabushiki Kaisha, Tokyo (JP)

(72) Inventor: Suguru KATO, Sunto Shizuoka (JP)

(21) Appl. No.: 18/805,443

(22) Filed: Aug. 14, 2024

(30) Foreign Application Priority Data
Oct. 18, 2023 (JP) 2023-179637

(51) Int. Cl. G06Q 20/20; G06V 20/64; G07G 1/00; G07G 1/01

(52) U.S. Cl. CPC G06Q 20/208; G06V 20/64; G07G 1/0036; G07G 1/01

(57) ABSTRACT

A point-of-sale system includes a camera attachable to a shopping cart and a POS terminal attachable to the shopping cart and including: an interface connectable to the camera, a storage device that stores dictionary data, a display device, and a processor configured to: control the camera to capture an image, execute a recognition process to determine a feature value of an item in the image and search the dictionary data for one or more candidate items, when one candidate item is recognized, register the item as a transaction item, and when multiple candidate items are recognized, determine the item in the image as a pending item, and associate the candidate items with the pending item, and upon receipt of an operation, control the display device to display a selection screen through which one of the candidate items is selectable, and register the selected item as the transaction item.

### CROSS-REFERENCE TO RELATED APPLICATION

This application is based upon and claims the benefit of priority from Japanese Patent Application No. 2023-179637, filed Oct. 18, 2023, the entire contents of which are incorporated herein by reference.

### FIELD

Embodiments described herein relate generally to a point-of-sale (POS) system, a method, and a storage medium.

### BACKGROUND

In a proposed system, an image of an item placed in a shopping cart by an operator, such as a customer, is captured, and the item is recognized based on the image and automatically registered as a transaction item. Such a system is called, for example, a frictionless cart, an artificial intelligence (AI) cart, a smart cart, or an intelligent cart.

However, depending on how the item appears in the image, the item might not be identifiable from among multiple candidate items. In such a case, it is necessary to stop newly recognizing items and determine the item as a transaction item based on an operation by the operator.

This necessitates the operator to stop placing items in the shopping cart and operate, for example, a terminal provided on the shopping cart, and thereby increases the burden on the operator.

In view of the above problem, there is a demand for a transaction processing system that can reduce the burden on the operator.

### SUMMARY OF THE INVENTION

Embodiments of the present invention provide a POS system, a method, and a storage medium that can reduce the burden on an operator.

In one embodiment, a POS system installed in a store, comprises: a camera attachable to a shopping cart; and a POS terminal attachable to the shopping cart and including: an interface connectable to the camera, a storage device that stores dictionary data in which items sold in the store are associated with feature values of images of the items, a display device with a touch panel, and a processor configured to: generate transaction data and store the transaction data in the storage device, control the camera to capture an image, execute an image recognition process to determine a feature value of an item appearing in the image and search the dictionary data for one or more candidate items, when one candidate item is recognized through the recognition process, register the candidate item as a transaction item in the transaction data, and when multiple candidate items are recognized through the recognition process, determine the item appearing in the image as a pending item, and associate the candidate items with the pending item, and upon receipt of an operation via the touch panel, control the display device to display a selection screen through which one of the candidate items is selectable, and register the selected item as the transaction item in the transaction data.

### BRIEF DESCRIPTION OF THE DRAWINGS

FIG. 1 is a block diagram illustrating a schematic configuration of a transaction processing system and a circuit configuration of a cart terminal according to an embodiment.

FIG. 2 is a schematic diagram illustrating a configuration of transaction data according to an embodiment.

FIG. 3 is a schematic diagram illustrating a configuration of pending data according to an embodiment.

FIG. 4 is a perspective view of a cart to which a cart terminal according to an embodiment is attached.

FIG. 5 is a flowchart illustrating a transaction process according to an

embodiment.

FIG. 6 is a flowchart illustrating a transaction process according to an

embodiment.

### DETAILED DESCRIPTION

Hereinafter, embodiments will be described in detail with reference to the drawings. The present disclosure is not limited to the embodiments described below.

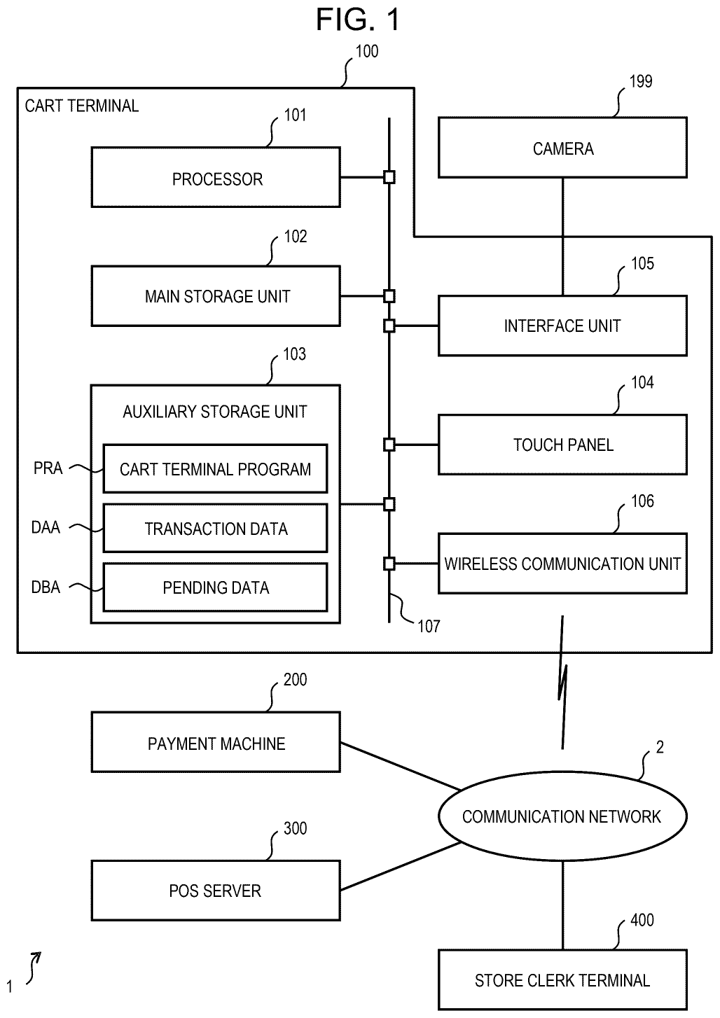

FIG. 1 is a block diagram illustrating a schematic configuration of a transaction processing system 1 and a circuit configuration of a cart terminal 100 according to an embodiment.

The transaction processing system 1 is a point-of-sale (POS) system that includes the cart terminal 100, a payment machine 200, a POS server 300, and a store clerk terminal 400 that are connected to each other via a communication network 2.

The communication network 2 may be implemented by, for example, the Internet, a Virtual Private Network (VPN), a Local Area Network (LAN), a public communication network, a mobile communication network, or any combination of these networks. In the present embodiment, it is assumed that the communication network 2 is implemented by a combination of the Internet and a mobile communication network.

In FIG. 1, the transaction processing system 1 includes one cart terminal 100, one payment machine 200, one POS server 300, and one store clerk terminal 400. However, the transaction processing system 1 may include any number of cart terminals 100, any number of payment machines 200, any number of POS servers 300, and any number of store clerk terminals 400.

The cart terminal 100 is an information processing apparatus that is attached to a shopping cart (hereinafter referred to as a cart) provided in a store. The cart terminal 100 is lent together with the cart to a customer who shops at a store. In response to an operation by the customer, the cart terminal 100 executes a transaction process to register items to be purchased by the customer as transaction items. Note that a store clerk may also be an operator of the cart terminal 100.

The payment machine 200 is an information processing apparatus that is installed in a store and executes a payment process related to payment for transaction items registered by the cart terminal 100. The payment machine 200 receives operations by an operator during the payment process. The operator of the payment machine 200 is mainly a customer. In some cases, however, the store clerk may operate the payment machine 200.

The POS server 300 is an information processing apparatus that executes a management process for managing item transactions processed in transaction processes executed by the cart terminal 100 and in payment processes executed by the payment machine 200.

The store clerk terminal 400 is an information processing terminal operated by a store clerk. The store clerk terminal 400 provides user interfaces related to information processing for assisting operations that are performed by the store clerk and related to transactions processed by the transaction processing system 1. The operations performed by the store clerk include, for example, monitoring the status of a transaction being processed and appropriately assisting the customer.

The cart terminal 100 includes a processor 101, a main storage unit 102, an auxiliary storage unit 103, a touch panel 104, an interface unit 105, a wireless communication unit 106, and a transmission line 107. The processor 101, the main storage unit 102, the auxiliary storage unit 103, the touch panel 104, the interface unit 105, and the wireless communication unit 106 can communicate with each other via the transmission line 107.

A computer that performs information processing for controlling the cart terminal 100 is formed by connecting the processor 101, the main storage unit 102, and the auxiliary storage unit 103 to each other via the transmission line 107.

The processor 101 corresponds to a central part of the computer. The processor 101 performs information processing for controlling other components of the cart terminal 100 to implement various functions of the cart terminal 100 according to information processing programs, such as an operating system and an application program.

The main storage unit 102 corresponds to a main storage device of the computer. The main storage unit 102 includes a read-only memory area and a rewritable memory area. The main storage unit 102 stores some of the information processing programs in the read-only memory area. Also, the main storage unit 102 may store, in the read-only memory area or the rewritable memory area, data necessary for the processor 101 to perform the information processing for controlling other components of the cart terminal 100. The main storage unit 102 uses the rewritable memory area as a work area for the processor 101.

The auxiliary storage unit 103 corresponds to an auxiliary storage device of the computer and is an example of a storage device in the present disclosure. The auxiliary storage unit 103 may be, for example, an electrically erasable programmable read-only memory (EEPROM), a hard disk drive (HDD), a solid state drive (SSD), or any other known storage device. The auxiliary storage unit 103 stores data used by the processor 101 to perform various types of processing and data generated by the processing performed by the processor 101. The auxiliary storage unit 103 may also store the information processing programs described above. In the present embodiment, the auxiliary storage unit 103 stores a cart terminal program PRA that is one of the information processing programs. The cart terminal program PRA is an application program describing control processes for implementing various functions of the cart terminal 100. The control processes include a transaction process described later. A part of the storage area of the auxiliary storage unit 103 is used to store transaction data DAA and pending data DBA. The transaction data DAA includes a list of registered transaction items in one transaction. The pending data DBA is related to an item (hereinafter referred to as a pending item) the registration of which is on hold in a transaction. The pending data DBA is generated by the transaction process in association with each pending item and stored in the auxiliary storage unit 103. Accordingly, when there is no pending item, no pending data DBA is stored in the auxiliary storage unit 103. When there is one pending item, one set of pending data DBA associated with the pending item is stored in the auxiliary storage unit 103. When there are multiple pending items, multiple sets of pending data DBA associated with the pending items are stored in the auxiliary storage unit 103.

The touch panel 104 displays screens for presenting information to the operator. That is, the touch panel 104 is an example of a display device. Also, the touch panel 104 receives instructions corresponding to touch operations performed by the operator on the screens.

The interface unit 105 is connected to an external device, such as a camera 199. The interface unit 105 interfaces data exchange with the connected external device. The interface unit 105 may be implemented by, for example, a universal serial bus (USB) controller. The camera 199 captures an image of an imaging range including the entire internal space of a shopping basket placed on the cart. Then, the camera 199 outputs image data representing the captured image. In other words, the camera 199 is an example of an imaging device that captures images of items. The camera 199 may repeatedly capture images at a regular interval or may capture an image in response to an instruction from the processor 101.

The wireless communication unit 106 executes a communication process for wireless data communication via the communication network 2. As the wireless communication unit 106, for example, a conventional wireless communication device for a wireless LAN can be used. In place of or in addition to the wireless communication unit 106, a communication unit wired to the communication network 2 may be used.

The transmission line 107 includes an address bus, a data bus, a control signal line, and the like, and transmits data and control signals exchanged between the components of the cart terminal 100.

A tablet information processing apparatus may be used as the basic hardware of the cart terminal 100.

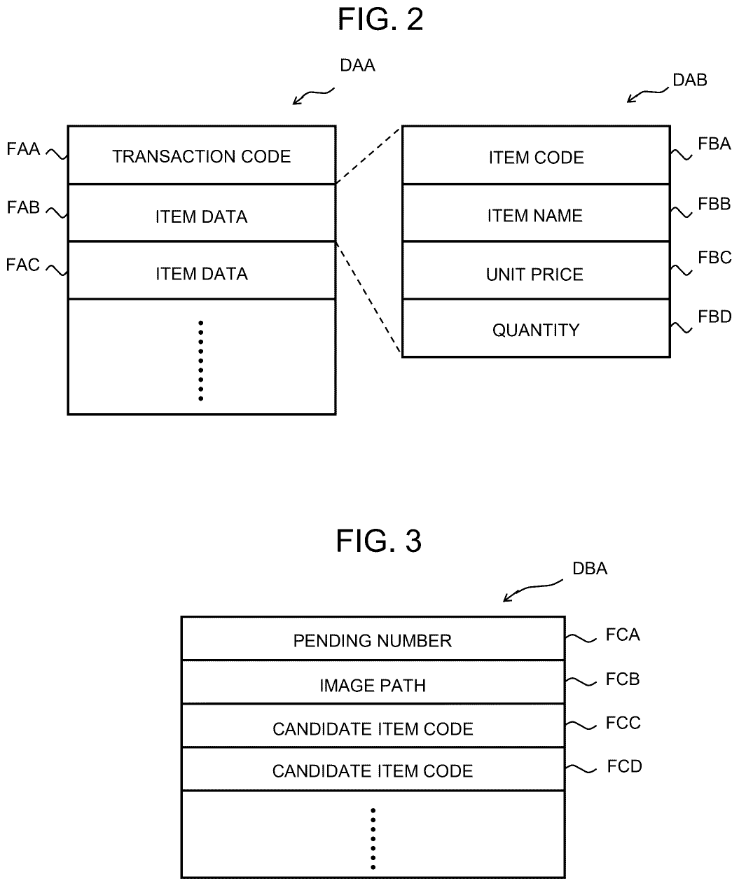

FIG. 2 is a schematic diagram illustrating a configuration of the transaction data DAA.

The transaction data DAA is generated for a transaction being processed by the cart terminal 100 and is stored in the auxiliary storage unit 103.

The transaction data DAA includes a field FAA and may further include a field FAB and any number of subsequent fields. In the field FAA, a transaction code is set as an identifier of the corresponding transaction. When transaction items are registered, fields FAB, FAC, . . . corresponding to the transaction items are added to the transaction data DAA. In each of the fields FAB, FAC, . . . , item data DAB related to the corresponding transaction item is set.

Each set of item data DAB includes fields FBA, FBB, FBC, and FBD. An item code, which is an identifier of the corresponding transaction item, is set in the field FBA. In the field FBB, an item name of the corresponding transaction item is set. The unit price of the corresponding transaction item is set in the field FBC. The quantity of the corresponding transaction item is set in the field FBD. The item data DAB may further include other types of information, such as discount information.

FIG. 3 is a schematic diagram illustrating a configuration of the pending data DBA.

The pending data DBA includes fields FCA and FCB. The pending data DBA may further include a field FCC and subsequent fields. A pending number is set in the field FCA to identify each set of pending data DBA when multiple sets of pending data DBA are stored in the auxiliary storage unit 103. In the field FCB, a file path (hereinafter referred to as an image path) of image data used to recognize the corresponding pending item is set. When there are one or more candidate items for the pending item, fields FCC, FCD, . . . associated with the candidate items are added to the pending data DBA. In the fields FCC, FCD, . . . , item codes (hereinafter referred to as candidate item codes) of the corresponding candidate items are set.

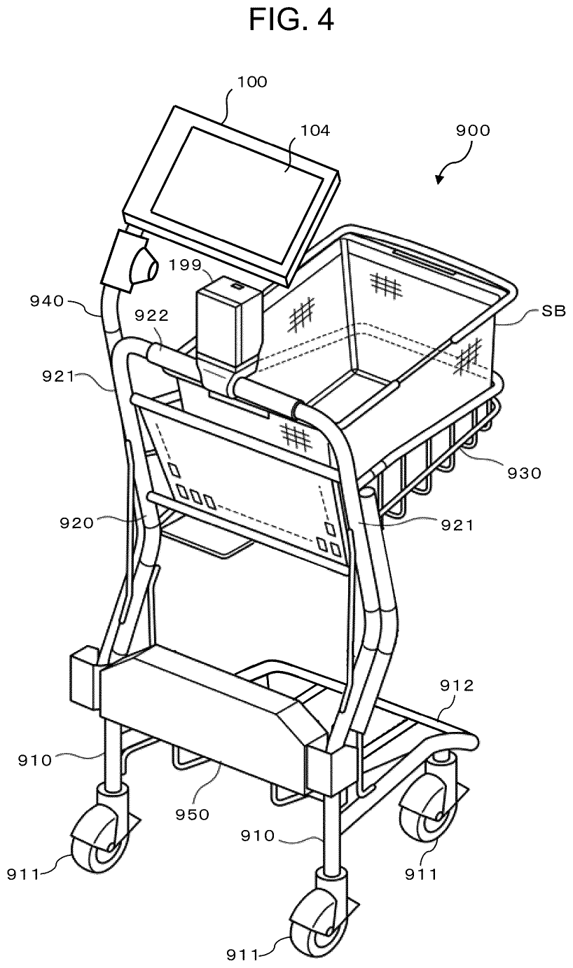

FIG. 4 is a perspective view of a cart 900 to which the cart terminal 100 is attached.

The cart 900 includes a caster unit 910, a handle frame unit 920, and a basket receiving unit 930.

The caster unit 910 includes four wheels 911 for smoothly moving the cart 900 on the floor. The wheels 911 are attached to a frame 912 so as to be rotatable about vertical axes.

The handle frame unit 920 includes a pair of vertical frames 921 and a handlebar 922. The vertical frames 921 are positioned upright above two wheels of the caster unit 910. The handlebar 922 connects the upper ends of the vertical frames 921 to each other.

The basket receiving unit 930 is provided to extend horizontally from an intermediate portion of the handle frame unit 920. The basket receiving unit 930 holds a shopping basket SB that is a container for storing items. The caster unit 910 can also hold the shopping basket SB on the frame 912.

The customer using the cart 900 is typically located behind the handle frame unit 920 in FIG. 4. The customer then pushes the cart 900 while grasping the handlebar 922. In this case, the basket receiving unit 930 protrudes from the handle frame unit 920 in the forward movement direction of the cart 900.

A camera 199 is attached to an intermediate portion of the handlebar 922 so that the camera 199 can capture a bird's-eye view image, or an image from above, of the inside of the shopping basket SB on the basket receiving unit 930. Also, a pole 940 is attached to one of the vertical frames 921 such that the distal end of the pole 940 is positioned above the handlebar 922. The cart terminal 100 described above is attached to the distal end of the pole 940 such that the touch panel 104 faces a direction opposite the forward movement direction.

A battery case 950 is provided between the vertical frames 921 near the lower end of the handle frame unit 920. The battery case 950 houses a battery used as an external power source of the cart terminal 100.

Next, operations of the transaction processing system 1 configured as described above will be described. Note that a process described below is an examples, the order of some steps in the process may be changed, some steps in the process may be omitted, and steps may be added to the process as appropriate. Also, descriptions of some steps are omitted to explain characteristic operations of the present embodiment in a more easily understandable manner. For example, when an error occurs, steps to address the error are normally performed. However, such steps are omitted in the example below.

The customer performs a predetermined operation to start using the cart terminal 100 not being used. When this operation is performed, the processor 101 starts a transaction process based on the cart terminal program PRA.

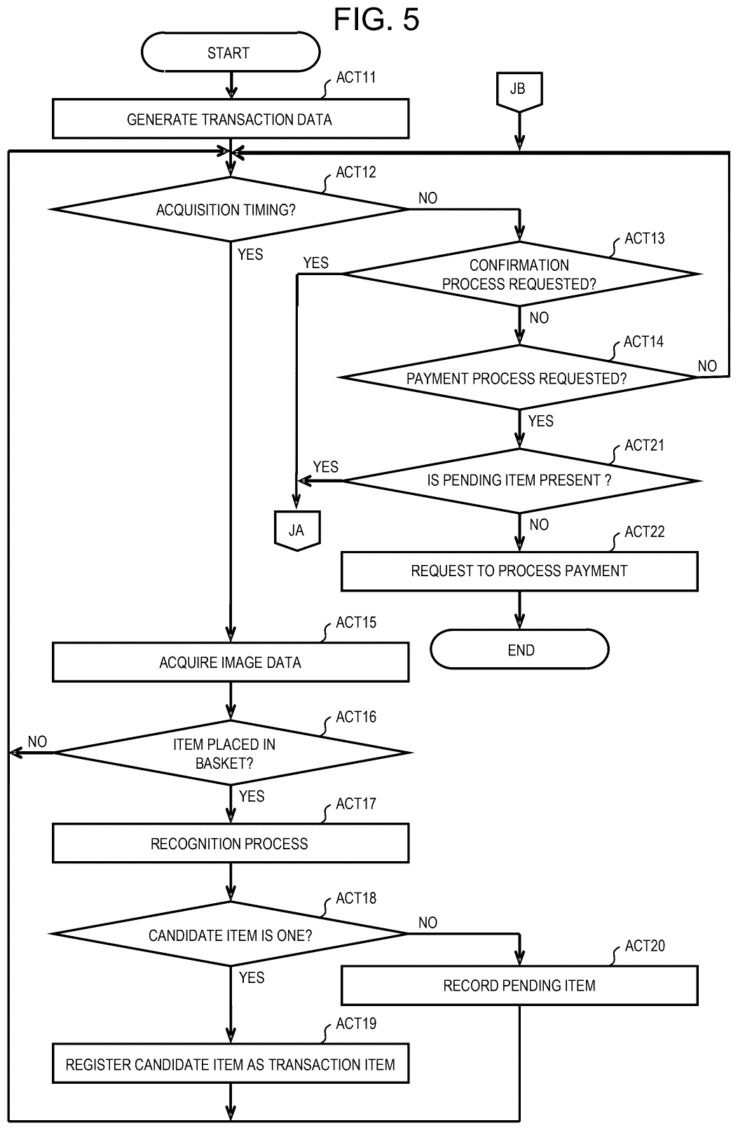

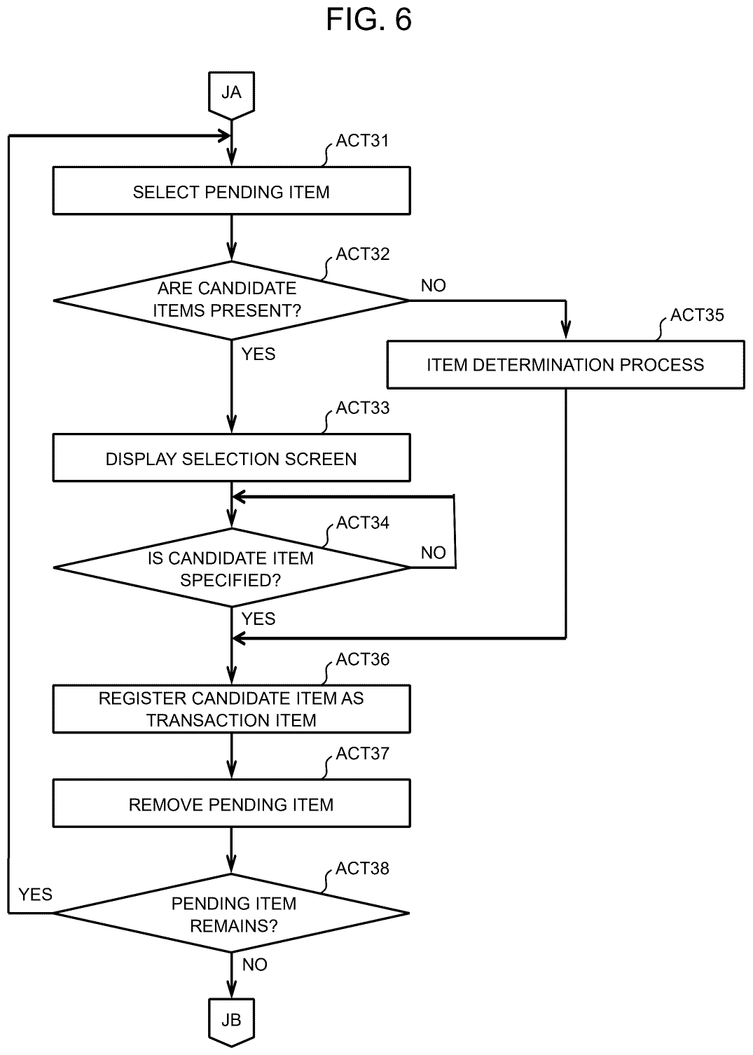

FIG. 5 and FIG. 6 are flowcharts illustrating the transaction process.

In ACT11, the processor 101 generates new transaction data DAA for a target transaction. That is, the processor 101 determines, for example, a new transaction code, which is different from transaction codes for identifying other transactions, according to a predetermined rule, generates new transaction data DAA including the transaction code and not including item information related to transaction items, and stores the new transaction data DAA in the auxiliary storage unit 103.

In ACT12, the processor 101 determines whether an acquisition timing for acquiring image data has arrived. When the acquisition timing has not arrived, the processor 101 proceeds to ACT13. For example, the acquisition timing arrives immediately after the process proceeds from ACT11 to ACT12 and at every predetermined time interval thereafter. Also, the acquisition timing may be appropriately determined by, for example, a creator of the cart terminal program PRA. In ACT13, the processor 101 determines whether a confirmation process for confirming pending items has been requested. When the confirmation process has not been requested, the processor 101 proceeds to ACT14.

In ACT14, the processor 101 determines whether a payment process has been requested. When the payment process has not been requested, the processor 101 returns to ACT12.

Thus, in ACT12 to ACT14, the processor 101 waits for the acquisition timing, the request for the confirmation process, or the request for the payment process.

When determining in ACT12 that the acquisition timing has arrived, the processor 101 proceeds to ACT15.

In ACT15, the processor 101 acquires image data output by the camera 199. For example, when the camera 199 is configured to repeatedly capture image data at a predetermined interval, the processor 101 acquires image data most recently captured by the camera 199. On the other hand, when the camera 199 is configured to capture image data in response to an instruction from the processor 101, the processor 101 instructs the camera 199 to capture image data and acquires the image data captured by the camera 199 in response to the instruction. The processor 101 stores the acquired image data in the main storage unit 102 or the auxiliary storage unit 103.

In ACT16, the processor 101 determines whether any item is placed in the shopping basket SB. When determining that no item is placed in the shopping basket SB, the processor 101 returns to the standby state in ACT12 to ACT14.

At an initial acquisition timing immediately after proceeding from ACT11 to ACT12, in many cases, no item is present in an image represented by the image data acquired in ACT15. Therefore, the processor 101 determines that no item is placed in the shopping basket SB when ACT16 is executed for the first time and returns to the standby state in ACT12 to ACT14. Then, the processor 101 repeats ACT15 and ACT16 at every acquisition timing. Here, the processor 101 retains image data (hereinafter referred to as past data) that has been acquired by executing ACT15 in a predetermined period of time in the past and stored in the main storage unit 102 or the auxiliary storage unit 103.

The customer searches for an item to be purchased in the store. Then, the customer takes out the item from the sales floor and places the item in the shopping basket SB.

For example, the processor 101 determines whether there is an item newly placed in the shopping basket SB on the basis of a difference between image data (hereinafter, referred to as current data) newly acquired in ACT15 and past data. The processor 101 may monitor the movement of a hand holding an item on the basis of current data and multiple sets of past data and determine that the item is placed in the shopping basket SB based also on the movement of the hand. When determining in ACT16 that a new item is placed in the shopping basket SB, the processor 101 proceeds to ACT17.

In ACT17, the processor 101 executes a recognition process of recognizing the item detected in ACT16. The processor 101, for example, inputs the current data to an image recognition engine trained by machine learning to detect the item and extract a feature of the item. Then, for example, the processor 101 searches a matching dictionary including items and features associated with the items based on the extracted feature to find one or more items with similarity scores greater than or equal to a threshold value. Then, the processor 101 identifies the found one or more items as candidate items. When no item with a similarity score greater than or equal to the threshold value is found, the processor 101 determines that no candidate item is found. Thus, the processor 101 performs information processing based on the cart terminal program PRA so that the computer having the processor 101 as a central part functions as a selection unit that attempts to select candidate items.

In ACT18, the processor 101 determines whether there is only one candidate item. When determining that there is only one candidate item, the processor 101 proceeds to ACT19.

In ACT19, the processor 101 registers the only one candidate item found in ACT17 as a transaction item. For example, the processor 101 updates the transaction data DAA to add the candidate item as one of transaction items. Thus, the processor 101 performs information processing based on the cart terminal program PRA so that the computer having the processor 101 as a central part functions as a first registering unit. The processor 101 then returns to the standby state in ACT12 to ACT14.

When determining in ACT 18 that multiple candidate items are found or no candidate item is found in ACT17, the processor 101 proceeds to ACT20.

In ACT20, the processor 101 records the item detected in ACT16 as a pending item. That is, the processor 101, for example, generates new pending data DBA and stores the new pending data DBA in the auxiliary storage unit 103. The processor 101 sets the field FCA of the new pending data DBA to a number that differs from the numbers set in the fields FCA of other sets of pending data DBA previously stored in the auxiliary storage unit 103. The processor 101 sets the file path of the current data in the field FCB of the new pending data DBA. When multiple candidate items are found in ACT17, the processor 101 sets the item codes of the candidate items in the field FCC and subsequent fields of the new pending data DBA. That is, the processor 101 records the candidate items in the new pending data DBA in association with the pending item. When no candidate item is found in ACT17, the processor 101 does not include the field FCC and subsequent fields in the new pending data DBA. Alternatively, the processor 101 may set a predetermined invalid value in the field FCC and subsequent fields of the new pending data DBA. Thus, the processor 101 performs information processing based on the cart terminal program PRA so that the computer having the processor 101 as a central part functions as a recording unit. The processor 101 then returns to the standby state in ACT12 to ACT14.

When the customer intends to purchase multiple items, the customer sequentially places the items in the shopping basket SB. In this case, the processor 101 repeats ACT17 and subsequent steps in the same manner as described above each time an item is placed in the shopping basket SB.

When the customer finishes placing all items to be purchased in the shopping basket SB, the customer performs a predetermined operation on, for example, the touch panel 104 to request a payment process. In response, the processor 101 determines in ACT14 that the payment process has been requested and proceeds to ACT21.

In ACT21, the processor 101 determines whether there is any pending item. In other words, the processor 101 determines whether pending data DBA is stored in the auxiliary storage unit 103. When at least one set of pending data DBA is stored in the auxiliary storage unit 103, the processor 101 determines that there is at least one pending item and proceeds to ACT31 in FIG. 6.

The customer can also perform a predetermined operation on the touch panel 104 to request a confirmation process for confirming pending items at any timing before all items to be purchased are placed in the shopping basket SB. For this purpose, for example, when there is a pending item, the processor 101 includes a display object, which indicates that there is a pending item, in a screen to be displayed on the touch panel 104 during the standby state in ACT12 to ACT14 in FIG. 5. Alternatively, for example, when there is a pending item, the processor 101 may activate a button that is on a screen displayed on the touch panel 104 during the standby state in ACT12 to ACT14 and used to receive an operation to request a confirmation process for the pending item. When determining in ACT13 that the confirmation process for the pending item has been requested, the processor 101 proceeds to ACT31 in FIG. 6. In other words, when the pending data DBA is stored in the auxiliary storage unit 103, the processor 101 controls the touch panel 104 to display a screen that enables the operator to request to display a selection screen described later.

In ACT31, the processor 101 selects one pending item. For example, the processor 101 reads one set of pending data DBA stored in the auxiliary storage unit 103 and sets the pending item related to the read pending data DBA as a selected pending item.

In ACT32, the processor 101 determines whether candidate items are present for the selected pending item. For example, the processor 101 determines that candidate items are present when the field FCC is included in the read pending data DBA. When determining in ACT32 that candidate items are present, the processor 101 proceeds to ACT33.

In ACT33, the processor 101 controls the touch panel 104 to display a selection screen including a list of the candidate items. The selection screen enables the operator to specify one of the candidate items. The selection screen is, for example, a graphical user interface (GUI) that displays an image based on image data specified by the file path set in the field FCB of the pending data DBA read in ACT31 and soft keys associated with the candidate items. Thus, the processor 101 performs information processing based on the cart terminal program PRA so that the computer having the processor 101 as a central part functions as a display unit.

The customer confirms the item appearing in the image displayed on the selection screen and specifies a candidate item from the candidate items on the selection screen by a predetermined operation, such as tapping a soft key associated with the candidate item.

In ACT34, the processor 101 waits until a candidate item is specified. When a candidate item is specified, the processor 101 proceeds to ACT36.

On the other hand, when the field FCC is not included in the pending data DBA read in ACT31, the processor 101 determines in ACT32 that no candidate item is present and proceeds to ACT35.

In ACT35, the processor 101 executes an item determination process. The item determination process determines an item in the image represented by the image data specified by the file path set in the field FCB of the pending data DBA read in ACT31. For example, the processor 101 executes the item determination process as described below. The processor 101 controls the touch panel 104 to display a screen that includes an image based on the image data specified by the file path set in the field FCB of the pending data DBA read in ACT31 and requests the operator to hold the item in the image in front of the camera 199. The processor 101 then repeats a recognition process similar to ACT17 based on an image obtained by the camera 199 until at least one candidate item is recognized. When only one candidate item is recognized, the processor 101 sets the candidate item as a determination result. When multiple candidate items are recognized, the processor 101 displays, on the touch panel 104, a selection screen similar to that displayed in ACT33 and sets a candidate item specified by the operator as a determination result. Alternatively, in the item determination process, a screen for calling a store clerk may be displayed on the touch panel 104, and an item specified by the store clerk may be set as a determination result. The type of item determination process may be appropriately determined by, for example, a creator of the cart terminal program PRA. Then, when an item is determined, the processor 101 proceeds to ACT36.

In ACT36, the processor 101 registers the candidate item specified in ACT34 or the item determined in ACT35 as a transaction item. For example, the processor 101 updates the transaction data DAA to add the transaction item as one of transaction items. Thus, when the process proceeds from ACT34 to ACT36, the processor 101 performs information processing based on the cart terminal program PRA so that the computer having the processor 101 as a central part functions as a second registering unit. When the process proceeds from ACT35 to ACT36, the processor 101 performs information processing based on the cart terminal program PRA so that the computer having the processor 101 as a central part functions as a third registering unit.

In ACT37, the processor 101 removes the pending item selected in ACT31. That is, for example, the processor 101 deletes the pending data DBA read in ACT31 from the auxiliary storage unit 103 after a candidate item associated with the pending item is registered as a transaction item.

In ACT38, the processor 101 determines whether there is a remaining pending item in the same manner as in ACT21 in FIG. 5. When determining that there is a remaining pending item, the processor 101 returns to ACT31 in FIG. 6 and repeats ACT 31 and subsequent steps in the same manner as described above. In this case, because the pending item previously selected in ACT31 has been removed, the processor 101 selects another pending item that has not been selected in ACT31. The processor 101 registers the pending item as a transaction item in ACT 32 through ACT37. When all pending items are registered as transaction items and it is determined in ACT38 that no pending item remains, the processor 101 returns to the standby state in ACT12 to ACT14 in FIG. 5.

When a payment process is requested in ACT14 and no pending item is present in ACT21, the processor 101 proceeds to ACT22.

In ACT22, the processor 101 requests, for example, the payment machine 200 to process the payment for all registered transaction items. That is, for example, the processor 101 transmits the transaction data to the payment machine 200 and requests the payment machine 200 to process the payment. Alternatively, when, for example, a payment terminal (not shown) is attached to the cart 900 and connected to the cart terminal 100, the processor 101 may calculate the price for the transaction items and request the payment terminal to process the payment for the calculated price by credit payment, code payment, or the like. Also, the processor 101 may calculate the price for the transaction items and request an online payment server (not shown) to process the payment for the calculated price. Thus, the processor 101 performs information processing based on the cart terminal program PRA so that the computer having the processor 101 as a central part functions as a payment unit. The processor 101 then ends the transaction process for one transaction.

In the present embodiment, after registering pending items as transaction items as described above, the processor 101 returns to the standby state in ACT12 to ACT14 in FIG. 5 to receive a request for a payment process. However, the processor 101 may proceed to the process illustrated in FIG. 6 when it is determined in ACT21 of FIG. 5 that a pending item is present, and may proceed to ACT22 of FIG. 5 when it is determined in ACT38 of FIG. 6 that no pending item remains.

As described above, when only one candidate item is found by the recognition process, the cart terminal 100 registers the candidate item as a transaction item. When multiple candidate items are found or when no candidate item is found, the cart terminal 100 records the item as a pending item and continues the process for registering other items. When determining that any pending item is present upon receiving a request for a payment process, the cart terminal 100 executes a process to determine an item matching the pending item and register the item as a transaction item.

With the above configuration, even when an item cannot be registered as a transaction item based on the recognition result, it is possible to continue a process to register items subsequently placed in the shopping basket SB. Thus, the operator can sequentially place items to be purchased in the shopping basket SB regardless of whether items already placed in the shopping basket SB have been correctly registered. This makes it possible to reduce the burden on the operator compared with a case where confirmation needs to be performed each time it is determined that an item cannot be registered as a transaction item based on the recognition result.

Also, even before a payment process is requested, the cart terminal 100 can perform a process for determining an item matching the pending item and registering the item as a transaction item in accordance with an instruction from the operator. This enables the customer to also perform confirmation of pending items at desired timing.

Various modifications may be made to the above embodiment as described below.

A part of the process executed by the processor 101 in the above-described embodiment may be executed by the POS server 300 or one or more of other information processing apparatuses. For example, the cart terminal 100 may function only as a user interface, and various types of information processing for identifying transaction items may be executed by a computer provided in the POS server 300. That is, the selection unit, the first registration unit, the second registration unit, the third registration unit, the recording unit, the display unit, and the payment unit may be implemented by any information processing apparatus that is different from the cart terminal 100 and included in the transaction processing system 1, or may be implemented in a distributed manner by multiple information processing apparatuses included in the transaction processing system 1.

Some or all of the functions implemented by the information processing performed by the processor 101 may be implemented by hardware, such as a logic circuit, that performs information processing not based on a program. Each of the above-described functions may also be implemented by a combination of software control and hardware, such as a logic circuit.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A point-of-sale (POS) system installed in a store, comprising:
a camera attachable to a shopping cart; and
a POS terminal attachable to the shopping cart and including:
an interface connectable to the camera,
a storage device that stores dictionary data in which items sold in the store are associated with feature values of images of the items,
a display device with a touch panel, and
a processor configured to:
generate transaction data and store the transaction data in the storage device,
control the camera to capture an image,
execute an image recognition process to determine a feature value of an item appearing in the image and search the dictionary data for one or more candidate items,
when one candidate item is recognized through the recognition process, register the candidate item as a transaction item in the transaction data, and
when multiple candidate items are recognized through the recognition process,
determine the item appearing in the image as a pending item, and associate the candidate items with the pending item, and
upon receipt of an operation via the touch panel, control the display device to display a selection screen through which one of the candidate items is selectable, and register the selected item as the transaction item in the transaction data.

2. The POS system according to claim 1, wherein the processor is configured to:
store the captured image in the storage device in association with the candidate items, and control the display device to display the stored image in the selection screen.

3. The POS system according to claim 1, further comprising:
a payment machine, wherein
the processor is configured to:
upon receipt of an input of a request for executing a payment process through the touch panel, determine whether any pending item remains, and
upon determining that no pending item remains, issue a request to the payment machine to perform the payment process.

4. The POS system according to claim 1, wherein the processor is configured to, when no candidate item is recognized through the recognition process, control the display device to display a screen including the captured image and requesting to capture another image using the camera.

5. The POS system according to claim 1, wherein
the camera is positioned to capture an image of a space on the shopping cart for a shopping basket to be placed, and
the processor is configured to determine whether an item is placed in the shopping cart based on the captured image.

6. The POS system according to claim 5, wherein the camera is attachable to a handle of the shopping cart.

7. The POS system according to claim 1, wherein the processor is configured to:
generate pending data in which the pending item is associated with the candidate items, and store the pending data in the storage device, and
delete the stored pending data once one of the candidate items is registered as the transaction item.

8. The POS system according to claim 1, wherein the processor is configured to:
determine whether a capture timing has arrived, and
upon determining that the capture timing has arrived, control the camera to capture an image.

9. The POS system according to claim 8, wherein the processor is configured to execute the image recognition process to find one or more items with similarity scores greater than or equal to a threshold value and determine the found one or more items as one or more candidate items.

10. The POS system according to claim 1, wherein the processor is configured to, when any pending item remains, control the display device to display a screen that enables the operator to request to display the selection screen.

11. A method performed by a point-of-sale (POS) system, the method comprising:
storing, in a storage device, dictionary data in which items sold in the store are associated with feature values of images of the items;
generating transaction data and storing the transaction data in the storage device;
controlling a camera attached to a shopping cart to capture an image;
executing an image recognition process to determine a feature value of an item appearing in the image and search the dictionary data for one or more candidate items;
when one candidate item is recognized through the recognition process, registering the candidate item as a transaction item in the transaction data; and
when multiple candidate items are recognized through the recognition process,
determining the item appearing in the image as a pending item, and associating the candidate items with the pending item, and
upon an input of a particular operation,
displaying a selection screen through which one of the candidate items is selectable, and
registering the selected item as the transaction item in the transaction data.

12. The method according to claim 11, further comprising:
storing the captured image in the storage device in association with the candidate items, and
displaying the stored image in the selection screen.

13. The method according to claim 11, further comprising:
upon receipt of an input of a request for executing a payment process, determine whether any pending item remains; and
upon determining that no pending item remains, issue a request to a payment machine to perform the payment process.

14. The method according to claim 11, further comprising:
when no candidate item is recognized through the recognition process, displaying a screen that includes the captured image and requests to capture another image using the camera.

15. The method according to claim 11, further comprising:
determining whether an item is placed in the shopping cart based on the captured image, wherein
the camera is positioned to face a space on the shopping cart for a shopping basket to be placed.

16. The method according to claim 15, wherein the camera is attached to a handle of the shopping cart.

17. The method according to claim 11, further comprising:
generating pending data in which the pending item is associated with the candidate items, and storing the pending data in the storage device; and
deleting the stored pending data once one of the candidate items is registered as the transaction item.

18. The method according to claim 11, further comprising:
determining whether a capture timing has arrived; and
upon determining that the capture timing has arrived, controlling the camera to capture an image.

19. The method according to claim 18, wherein executing includes finding one or more items with similarity scores greater than or equal to a threshold value and determining the found one or more items as one or more candidate items.

20. A non-transitory computer-readable storage medium storing a program for causing a computer of a point-of-sale (POS) system to perform a process comprising:
storing, in a storage device, dictionary data in which items sold in the store are associated with feature values of images of the items;
generating transaction data and storing the transaction data in the storage device;
controlling a camera to capture an image;
executing an image recognition process to determine a feature value of an item appearing in the image and search the dictionary data for one or more candidate items;
when one candidate item is recognized through the recognition process, registering the candidate item as a transaction item in the transaction data; and
when multiple candidate items are recognized through the recognition process,
determining the item appearing in the image as a pending item, and associating the candidate items with the pending item, and
upon an input of a particular operation,
displaying a selection screen through which one of the candidate items is selectable, and
registering the selected item as the transaction item in the transaction data.
